(19) United States
(12) Patent Application Publication
(10) Pub. No.: US 2014/0244391 A1
(43) Pub. Date: Aug. 28, 2014

(54) ONLINE ADVERTISING METHOD AND SYSTEM

(71) Applicant: talktUp LLC, Bellevue, WA (US)

(72) Inventors: Frederick GOODIN, Bellevue, WA (US); Saif A. HAKIM, Bellevue, WA (US); Philip LEE, Seattle, WA (US); Matt COGGAN, Seattle, WA (US); Elijah ZUPANCIC, Bellevue, WA (US); Derek SHI, Bellevue, WA (US); David SHADLE, Bellevue, WA (US)

(73) Assignee: talktUp LLC, Bellevue, WA (US)

(21) Appl. No.: 13/969,248

(22) Filed: Aug. 16, 2013

Related U.S. Application Data
(60) Provisional application No. 61/770,862, filed on Feb. 28, 2013.

(51) Int. Cl. G06Q 30/02

(52) U.S. Cl. CPC G06Q 30/0257
USPC 705/14.55

(57) ABSTRACT

A first party creates offers, generally comprising advertisements, which are associated on a server with names and categories; the first party may also bid on placement of the offers in online content. A second party, such as a publisher, obtains a script which the publisher includes in the publisher's online content. When a user access the online content, the user's browser and/or an app or browser plugin (or similar) notifies the server and the server parses the online content for names. If any are found, then the server obtains offers associated with the names and other criteria, such as the location of the user and locations associated with the offers. The obtained offers are sent to and rendered by the user's client device. The server logs interaction with the client device, may obtain consideration from the first party, and may provide consideration to the second party.

### FIELD

This disclosure relates to online advertising.

### BACKGROUND

The following description includes information that may be useful in understanding the present invention. It is not an admission that any of the information provided herein is prior art or relevant to the presently claimed invention, or that any publication specifically or implicitly referenced is prior art.

Content on webpages (comprising text, audio, images, video, and graphical and structural elements) is often accompanied by advertisements. Advertising systems are known to select advertisements based on information regarding the person to whom the advertisement is to be presented.

### BRIEF DESCRIPTION OF THE DRAWINGS

FIG. 1 is a network and device diagram illustrating exemplary computing devices configured according to embodiments disclosed in this paper.

FIG. 2 is a functional block diagram of an exemplary Injection Server computing device and some data structures and/or components thereof.

FIG. 3 is a functional block diagram of the Injection Server Datastore illustrated in the computing device of FIG. 2.

FIG. 4 is a functional block diagram of an exemplary Client Device and some data structures and/or components thereof.

FIG. 5 is a functional block diagram of the Client Device Datastore illustrated in the computing device of FIG. 4.

FIG. 6 is a functional block diagram of an exemplary Offer Source computing device and some data structures and/or components thereof.

FIG. 7 is a functional block diagram of the Offer Source Datastore illustrated in the computing device of FIG. 6.

FIG. 8 is a functional block diagram of an exemplary Publisher computing device and some data structures and/or components thereof.

FIG. 9 is a functional block diagram of the Publisher Datastore illustrated in the computing device of FIG. 8.

FIG. 10 is a flowchart illustrating an embodiment of an Offer and Script Creation, Webpage Interaction, and Maintenance Process 1000 in which an Injection Server, Offer Source, Publisher, and Client Device interact to create Offers, provide an Injection Script to the Publisher, in which a Publisher serves a Webpage containing the Injection Script, and in which the Client Device renders the Injection Script and interacts with the Injection Server.

FIG. 11 is a flowchart illustrating an embodiment of an Offer Creation and Bid Process 1100 in which an Offer Source interacts with the Injection Server to create Offers.

FIG. 12 is a flowchart illustrating an embodiment of an Injection Script Generation Process 1200 in which an Injection Script is provided to a Publisher.

FIG. 13 is a flowchart illustrating an embodiment of a Webpage Interaction Process 1300 in which a Publisher serves Content containing the Injection Script and the Client Device renders the Injection Script.

FIG. 14 illustrates Content comprising an embodiment of two Offers which include a discount promotion.

FIG. 15 illustrates Content comprising an embodiment of an Offer which includes promotional information.

FIG. 16 illustrates Content comprising an embodiment of an Offer format.

FIG. 17 illustrates an Offer format embodiment.

FIG. 18 illustrates an Offer format embodiment.

FIG. 19 illustrates an Offer format embodiment.

FIG. 20 illustrates an Offer format embodiment.

### DETAILED DESCRIPTION

The following Detailed Description provides specific details for an understanding of various examples of the technology. One skilled in the art will understand that the technology may be practiced without many of these details. In some instances, structures and functions have not been shown or described in detail or at all to avoid unnecessarily obscuring the description of the examples of the technology. It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connection between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list.

Certain elements appear in certain of the Figures with the same capitalized element text, but a different element number. When referred to herein with the capitalized element text but with no element number, these references should be understood to be largely equivalent and to refer to any of the elements with the same capitalized element text, though potentially with differences based on the computing device within which the various embodiments of the element appears.

As used herein, a Uniform Resource Identifier (“URI”) is a string of characters used to identify a resource on a computing device and/or a network, such as the Internet. Such identification enables interaction with representations of the resource using specific protocols. “Schemes” specifying a syntax and associated protocols define each URI.

The generic syntax for URI schemes is defined in Request for Comments (“RFC”) memorandum 3986 published by the Internet Engineering Task Force (“IETF”). According to RFC 3986, a URI (including a URL) consists of four parts:

<scheme name>:<hierarchical part>[?<query>][#<fragment>]

A URI begins with a scheme name that refers to a specification for assigning identifiers within that scheme. The scheme name consists of a letter followed by any combination of letters, digits, and the plus (“+”), period (“.”), or hyphen (“-”) characters; and is terminated by a colon (“:”).

The hierarchical portion of the URI is intended to hold identification information that is hierarchical in nature. Often this part is delineated with a double forward slash (“/”), followed by an optional authority part and an optional path.

The optional authority part holds an optional user information part (not shown) terminated with “@” (e.g. username:password@), a hostname (i.e., domain name or IP address, here “example.com”), and an optional port number preceded by a colon “:”.

The path part is a sequence of one or more segments (conceptually similar to directories, though not necessarily representing them) separated by a forward slash (“/”). If a URI includes an authority part, then the path part may be empty.

The optional query portion is delineated with a question mark and contains additional identification information that is not necessarily hierarchical in nature. Together, the path part and the query portion identify a resource within the scope of the URI's scheme and authority. The query string syntax is not generically defined, but is commonly organized as a sequence of zero or more <key>=<value> pairs separated by a semicolon or ampersand, for example:

key1=value1;key2=value2;key3=value3 (Semicolon), or

key1=value1&key2=value2&key3=value3 (Ampersand)

Much of the above information is taken from RFC 3986, which provides additional information related to the syntax and structure of URIs. RFC 3986 is hereby incorporated by reference, for all purposes.

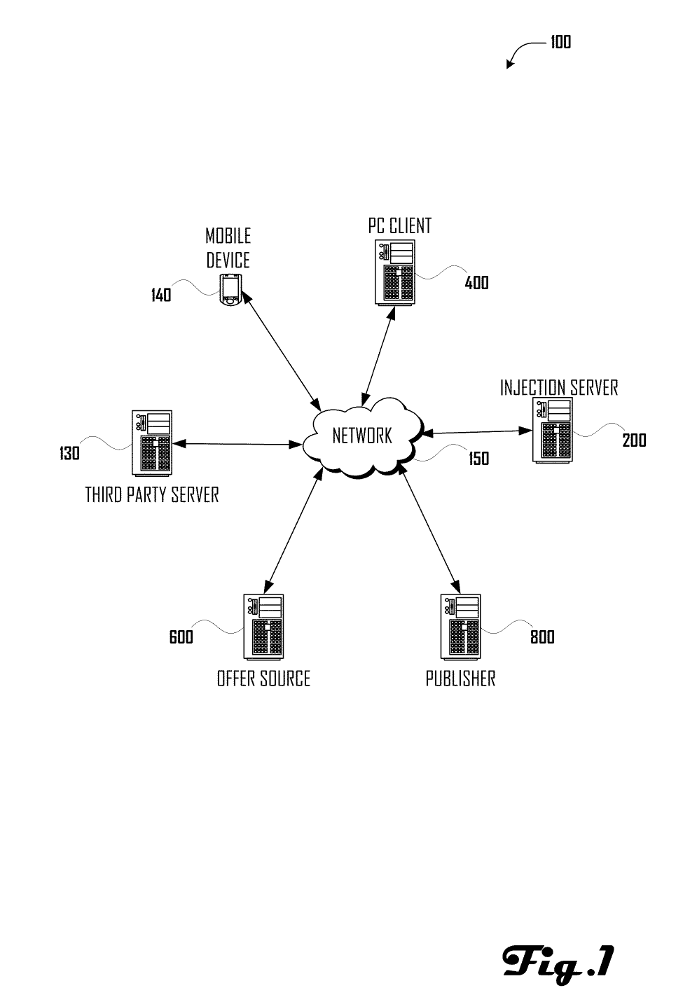

FIG. 1 is a network and device diagram illustrating exemplary computing devices configured according to embodiments disclosed in this paper. In FIG. 1, a PC Client 400 computer and Mobile Device 140 are illustrated as connecting to a Network 150, such as the Internet (which connection may be via a Wi-Fi connection), and/or to a wireless network, such as a GSM, TDMA, CDMA, EDGE, HSPA, LTE or other network provided by a wireless service provider. The PC Client 400 and the Mobile Device 140 are largely equivalent computing devices, differing, for example, in the user interface which they provide to users and/or in the Network 150 to which they connect. Both the PC Client 400 and the Mobile Device 140 may be referred to herein as a “Client Device.” Examples of Client Devices include personal computers, laptop computers, tablet computers, smart phones, digital televisions, e-readers or similar computing devices. Client Devices are used by “users.” Also illustrated as connecting to the Network 150 are an Injection Server 200, a Publisher 800, an Offer Source 600 and a Third Party Server 130.

Connection to the Network 150 may require that the computers execute software routines which enable, for example, the seven layers of the OSI model of computer networking or equivalent in a wireless phone network. The Network 150 comprises computers, network connections among the computers, and software routines to enable communication between the computers over the network connections.

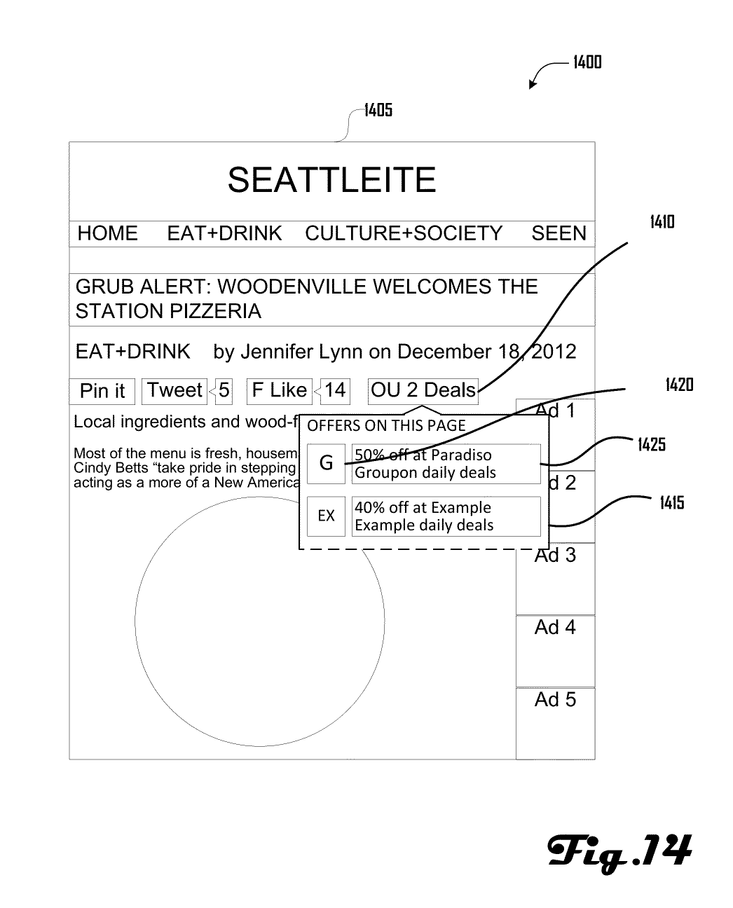

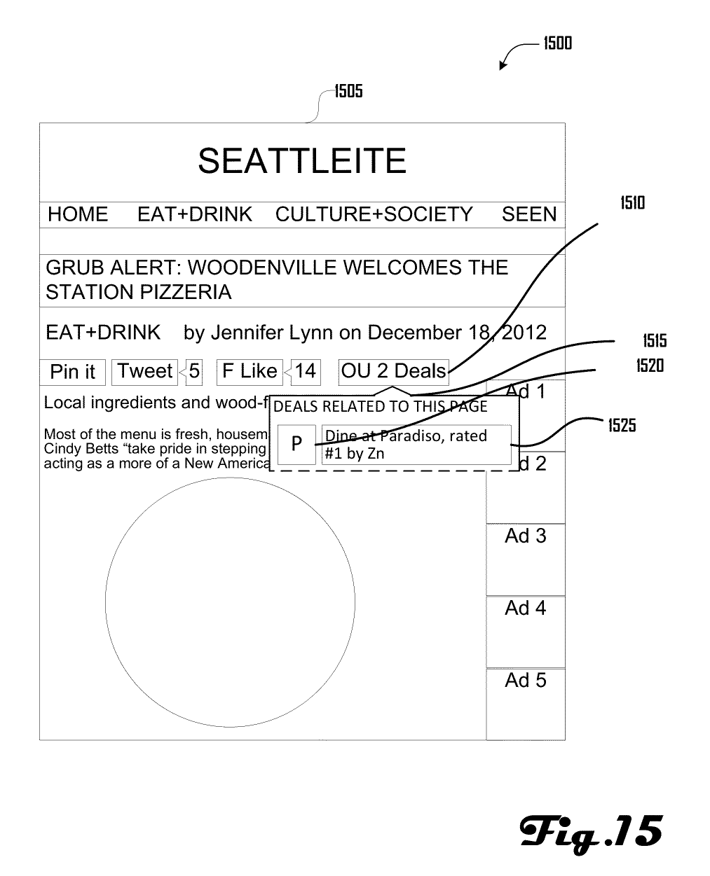

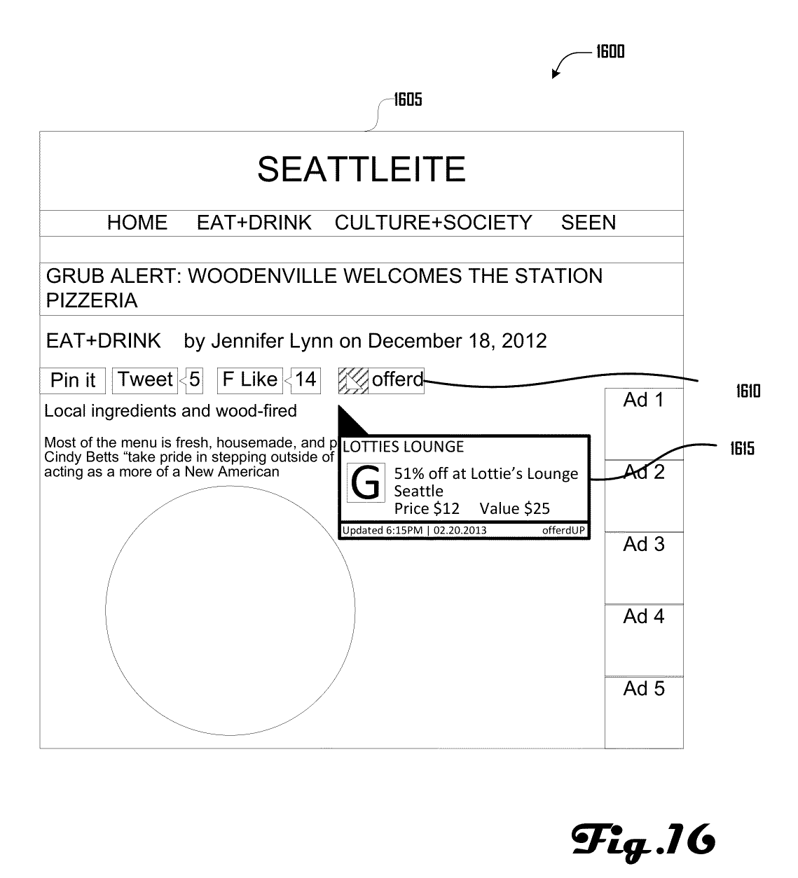

As discussed further herein, the Offer Sources 600 are parties who wish to place advertisements in content. As used herein, “Content” comprises webpages and equivalent user interfaces comprising text, audio, images, video, and graphical and structural elements. An example of Content is illustrated in FIG. 14, element 1405 (not including element 1410, 1415, 1420, and 1425, which illustrate Offers as disclosed herein). Content may be provided by, for example, Webpage Content 915 served by the Publisher 800. The advertisements may promote a product or service, advance a political or religious point of view, or may otherwise engage in speech. Offers may present information regarding a discount, such as a percentage or fixed amount off of a product or service, or may present other information promoting a product or service. FIG. 14 illustrates an Offer presenting discounts, while FIG. 15 illustrates an offer presenting other promotional information, while FIGS. 16 through 20 illustrate other embodiments of Offer formats. As discussed further herein, Offer Sources 600 may include, for example, a party who owns the good or service (a “Merchant”), advertisers who provide advertising services to the Merchant, and advertising network participants (parties who connect other Offer Sources to Publishers 800 and users), such as GROUPON™ and similar. Advertisements or other speech of or from an Offer Source 600 are referred to herein as “Offers” and may be identified at the Injection Server 200 by an Offer ID 325.

As discussed further herein, Publishers 800 include, for example, parties who publish Content, such as, for example, providers of websites which provide news, opinion, and/or entertainment content to users. An example of a Publisher's 800 Content is illustrated in FIG. 14, element 1405 (not including elements 1410, 1415, 1420, and 1425).

As discussed further herein, the Third Party Server 130 may represent, for example, online social media service providers, such as, for example, FACEBOOK®, TWITTER® and similar, and/or online search service providers, such as, for example, GOOGLE®, BING®, and similar. Creation of an account at the Injection Server 200 may involve the party who creates the account providing the Injection Server 200 with credentials, which credentials may include the credentials used by such party with the Third Party Server 130.

As discussed further herein, an Offer Source 600 may create an Offer and may bid on the placement of the Offer in association with Content based on, for example, a location of or associated with the user, a location of the underlying product or service, locations identified in the Content, and business names and product or service names in the Content (hereinafter referred to collectively as “Names”). An example of Content comprising an Offer is illustrated in FIG. 14, wherein the Content is all of the material within element 1405, while the Offer comprises, for example, the components within elements 1415, 1420, and 1425. The bottom of element 1415 is dotted to indicate that there may be additional Offers and that element 1415 may be expanded and/or that a scroll bar (or similar) may be provided to allow the user to scroll to additional Offers. Element 1410 in FIG. 14 is an embodiment of an example of an Offer Banner.

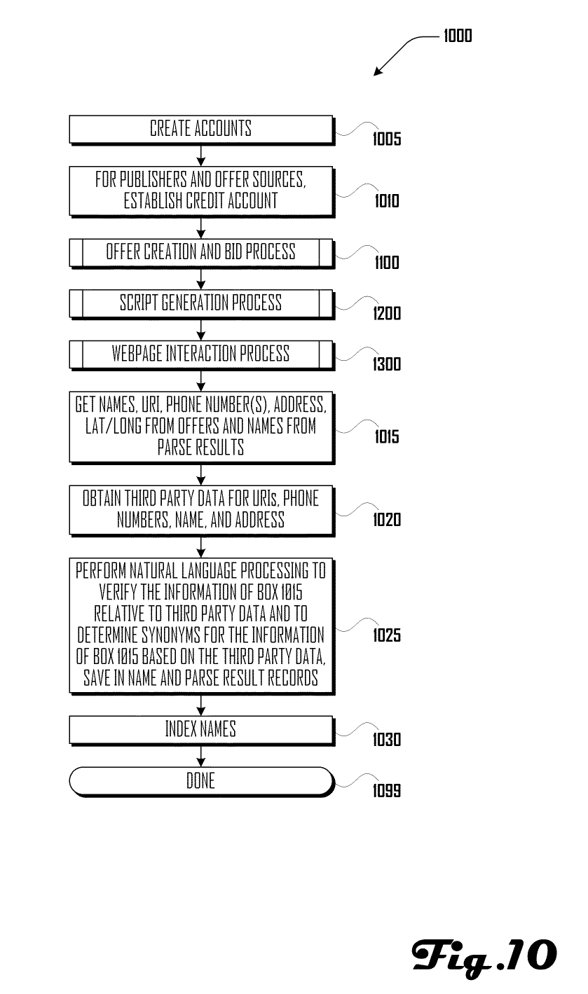

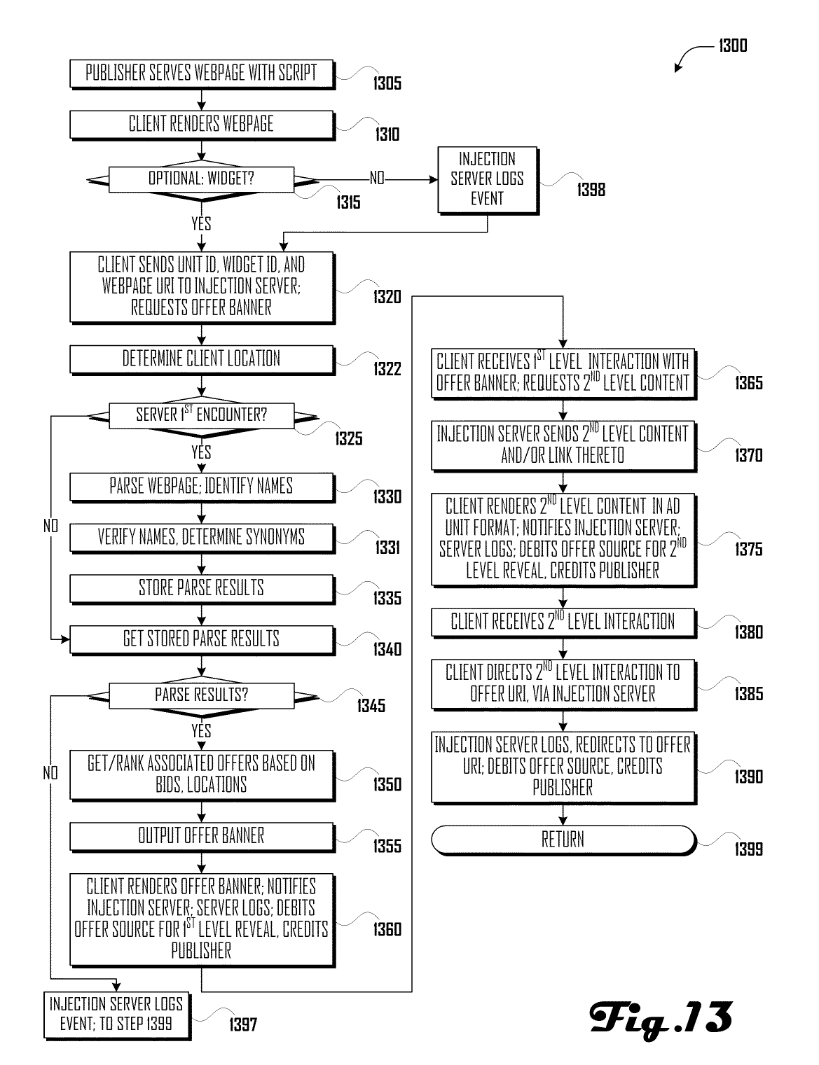

The Publisher 800 may create an account at the Injection Server 200 and may place a script, referred to herein as an “Injection Script,” on one or more webpages controlled by the Publisher 800. When rendered by a Client Device, the process outlined in FIGS. 10 and 13 causes the Injection Server 200 to determine Names in the Content, to match Offers to the Names (and other factors), to serve an Offer Banner, such as Offer Banner 1410, and the matched Offers, such as 1415 and 1425, along with the Content, to perform other interactions with the user, credit Publisher 800 accounts or otherwise provide Publishers 800 with consideration for serving the Offer, and debit Offer Sources 600 or otherwise obtain consideration from Offer Sources 600 for placement of the Offers on or in the Content.

This paper may discuss a first computer as connecting to a second computer (such as a Client Device connecting to the Injection Server 200) or to a corresponding datastore (such as Injection Server Datastore 300); it should be understood that such connections may be to, through, or via the other of the two components (for example, a statement that a computing device connects with or sends data to the Injection Server 200 should be understood as saying that the computing device may connect with or send data to the Injection Server Datastore 300). References herein to “database” should be understood as equivalent to “Datastore.” Although illustrated as components integrated in one physical unit, the servers and databases may be provided by common (or separate) physical hardware and common (or separate) logic processors and memory components.

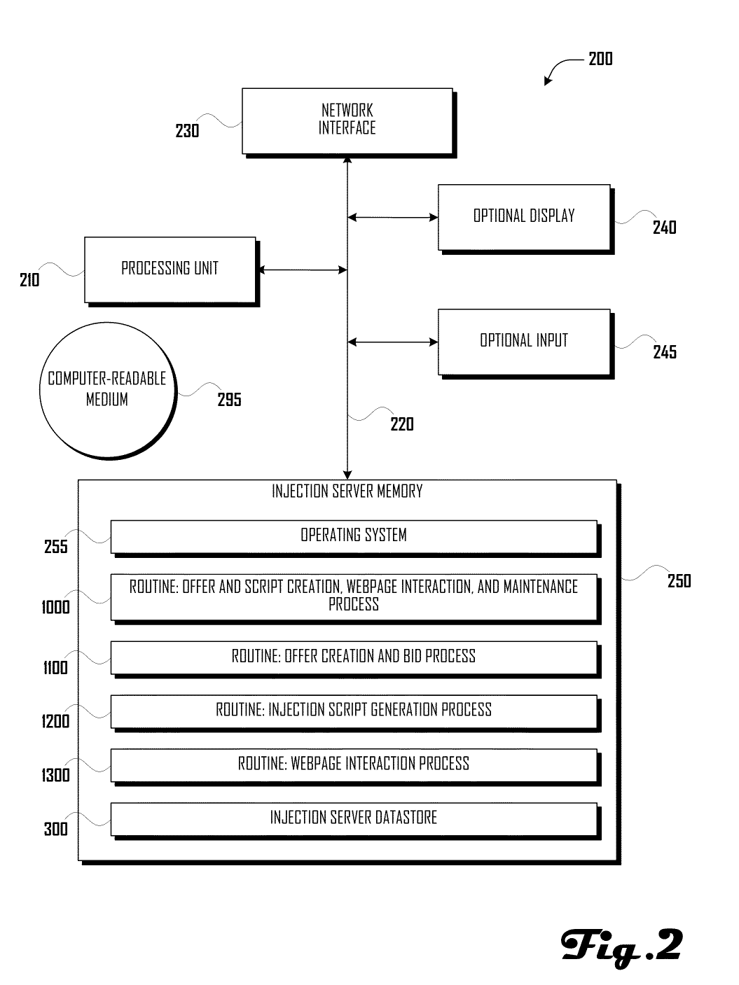

FIG. 2 is a functional block diagram of an exemplary Injection Server computing device and some data structures and/or components thereof. The computing device 200 in FIG. 2 comprises at least one Processing Unit 210, Injection Server Memory 250, and an Optional Display 240, all interconnected along with the Network Interface 230 via a Bus 220. The Network Interface 230 may be utilized to form connections with the Network 150. The Injection Server Memory 250 generally comprises a random access memory (“RAM”), a read only memory (“ROM”), and a permanent mass storage device, such as a disk drive or SDRAM (synchronous dynamic random-access memory). The Injection Server Memory 250 stores program code for software routines, such as, for example, the routines illustrated in these figures, as well as browser, email client and server routines, client applications, and database applications (discussed further below). In addition, the Injection Server Memory 250 also stores an Operating System 255. These software components may be loaded from a non-transient Computer Readable Storage Medium 295 into Injection Server Memory 250 of the computing device using a drive mechanism (not shown) associated with a non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

The computing device 200 may also comprise hardware supporting input modalities, Optional Input 245, such as, for example, a touchscreen, a keyboard, a mouse, a trackball, a stylus, a microphone, and a camera.

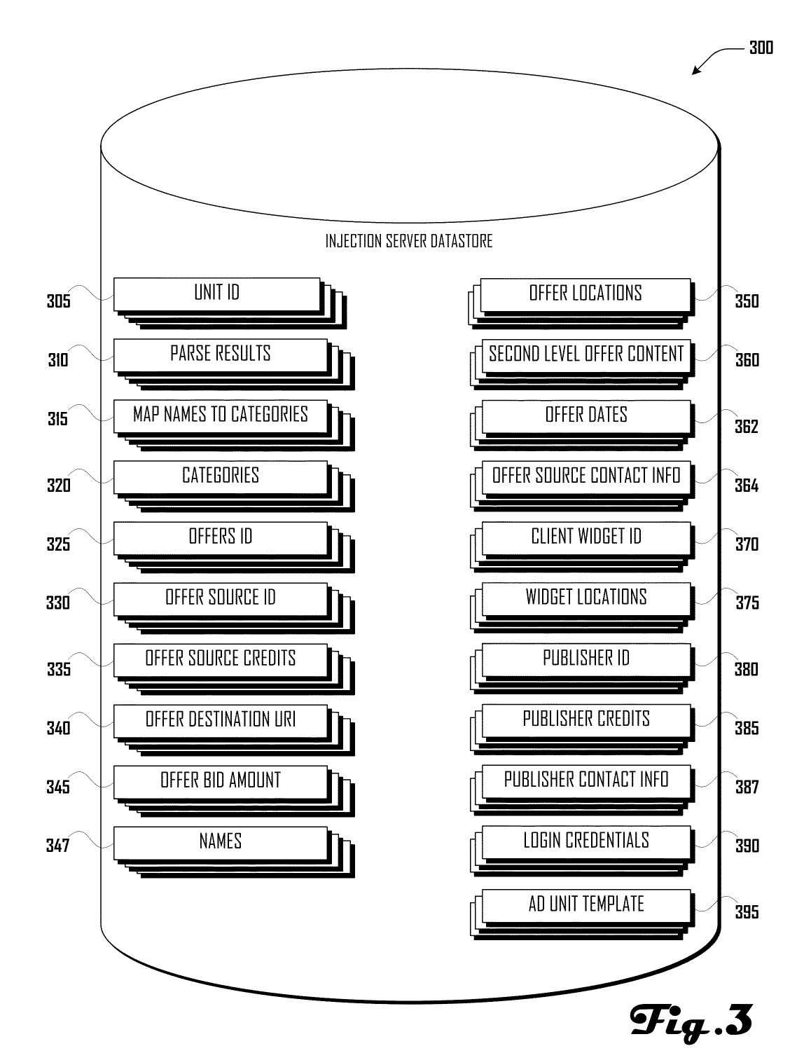

The computing device 200 may also comprise or communicate via Bus 220 with Injection Server Datastore 300, illustrated further in FIG. 3. In various embodiments, Bus 220 may comprise a storage area network (“SAN”), a high speed serial bus, and/or via other suitable communication technology. In some embodiments, computing device may communicate with the Injection Server Datastore via Network Interface 230. The computing device 200 may, in some embodiments, include many more components than those shown in this Figure. However, it is not necessary that all of these generally conventional components be shown in order to disclose an illustrative embodiment.

The Injection Server 200 illustrated in FIG. 2 comprises data groups for routines, such as routines for an Offer Creation and Bid Process 1100, an Injection Script Generation Process 1200, and a Scripted Webpage Interaction Process 1300. The Offer Creation and Bid Process 1100 is a software routine through which Offer Sources 600 can create Offers and bid on placement of them in Content. The Injection Script Generation Process 1200 is a software routine through which Publishers 800 can obtain Injection Scripts for placement in Content. The Scripted Webpage Interaction Process 1300 is a software routine through which users of Client Devices interact with Content, Offers, and the Injection Server 200. Additional data groups for routines, such as for a webserver and web browser, may also be present on and executed by the Injection Server 200. Browser routines may provide an interface for interacting with the other computing devices illustrated in FIG. 1, such as with the Client Devices, the Offer Sources 600, the Publisher 800, and the Third Party Server 130, for example, through webserver and web browser routines (which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 3 is a functional block diagram of the Injection Server Datastore illustrated in the computing device of FIG. 2. The components of the Injection Server Datastore 300 are data groups used by routines and are discussed further herein in the discussion of other of the Figures. The data groups used by routines illustrated in FIG. 3 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Certain of the data groups used by routines illustrated in FIG. 3 represent groups of classes of data groups, components of which are further defined herein.

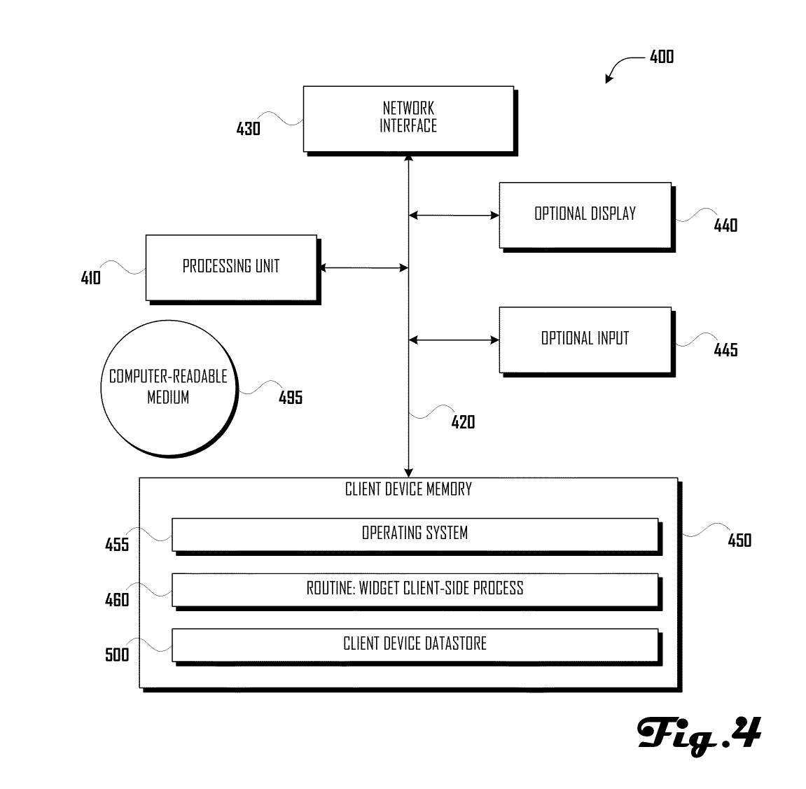

FIG. 4 is a functional block diagram of an exemplary Client Device and some data structures and/or components thereof. The computing device 400 in FIG. 4 comprises at least one Processing Unit 410, Client Device Memory 450, and an Optional Display 440, all interconnected along with the Network Interface 430 via a Bus 420. The Network Interface 430 may be utilized to form connections with the Network 150. The Client Device Memory 450 generally comprises a random access memory (“RAM”), a read only memory (“ROM”), and a permanent mass storage device, such as a disk drive or SDRAM (synchronous dynamic random-access memory). The Client Device Memory 450 stores program code for software routines, such as, for example, the routines illustrated in these figures, as well as browser, email client and server routines, client applications, and database applications (discussed further below). In addition, the Client Device Memory 450 also stores an Operating System 455. These software components may be loaded from a non-transient Computer Readable Storage Medium 495 into Client Device Memory 450 of the computing device using a drive mechanism (not shown) associated with a non-transient Computer Readable Storage Medium 495, such as a floppy disc, tape, DVD/CD-ROM drive, memory card, or other like storage medium. In some embodiments, software components may also or instead be loaded via a mechanism other than a drive mechanism and Computer Readable Storage Medium 495 (e.g., via Network Interface 430).

The computing device 400 may also comprise hardware supporting input modalities, Optional Input 445, such as, for example, a touchscreen, a keyboard, a mouse, a trackball, a stylus, a microphone, and a camera.

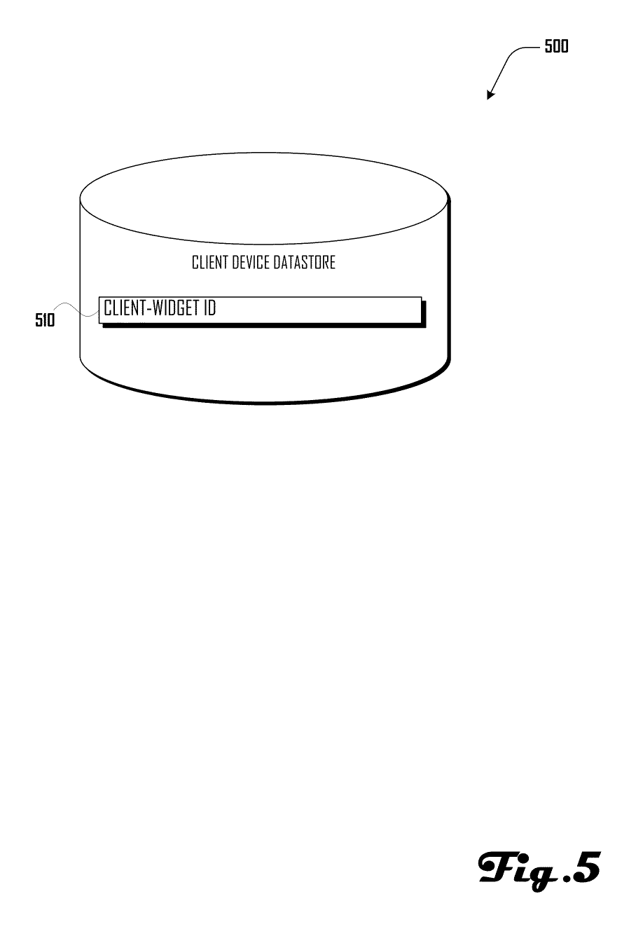

The computing device 400 may also comprise or communicate via Bus 420 with Client Device Datastore 500, illustrated further in FIG. 5. In various embodiments, Bus 420 may comprise a storage area network (“SAN”), a high speed serial bus, and/or via other suitable communication technology. In some embodiments, computing device may communicate with the Client Device Datastore 500 via Network Interface 430. The computing device 400 may, in some embodiments, include many more components than those shown in this Figure. However, it is not necessary that all of these generally conventional components be shown in order to disclose an illustrative embodiment.

The Client Device Computer 400 illustrated in FIG. 4 comprises data groups for routines, such as a routine for an optional Widget Client-Side Process 460. The Widget Client-Side Process 460 is an optional software routine which may interact with the Injection Server 200 in the Scripted Webpage Interaction Process 1300. Additional data groups for routines, such as for a webserver and web browser, may also be present on and executed by the Client Device. Browser routines may provide an interface for interacting with the other computing devices illustrated in FIG. 1, such as the Injection Server 200 and the Third Party Server 130, for example, through webserver and web browser routines (which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 5 is a functional block diagram of the Client Device Datastore illustrated in the computing device of FIG. 4. The components of the Client Device Datastore 500 are data groups used by routines and are discussed further herein in the discussion of other of the Figures. The data groups used by routines illustrated in FIG. 5 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Certain of the data groups used by routines illustrated in FIG. 5 represent groups of classes of data groups, components of which are further defined herein.

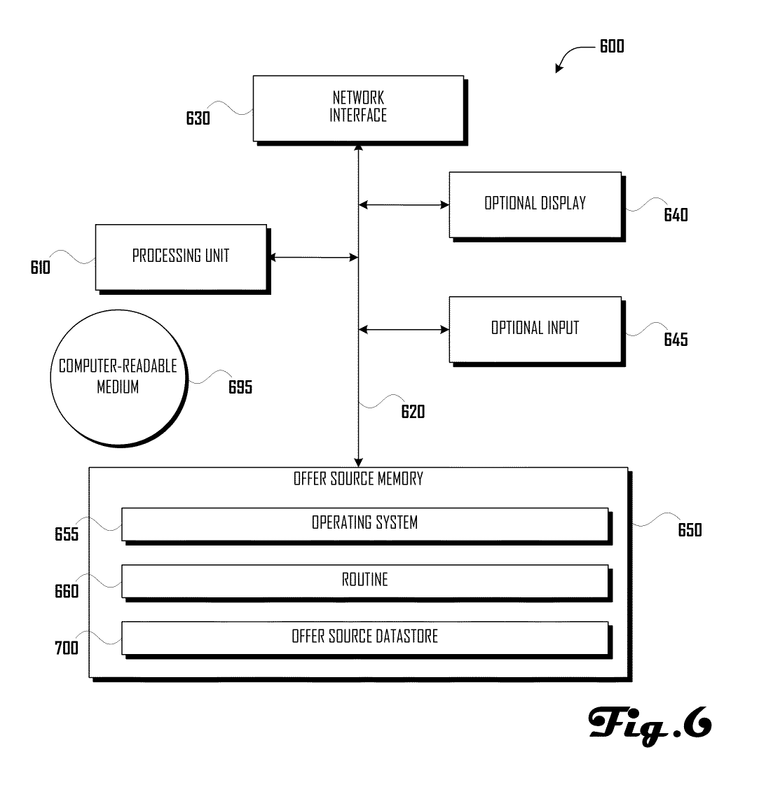

FIG. 6 is a functional block diagram of an exemplary Offer Source computing device and some data structures and/or components thereof. The computing device 600 in FIG. 6 comprises at least one Processing Unit 610, Offer Source Memory 650, and an Optional Display 640, all interconnected along with the Network Interface 630 via a Bus 620. The Network Interface 630 may be utilized for form connections with the Network 150. The Offer Source Memory 650 generally comprises a random access memory (“RAM”), a read only memory (“ROM”), and a permanent mass storage device, such as a disk drive or SDRAM (synchronous dynamic random-access memory). The Offer Source Memory 650 stores program code for software routines, such as, for example, a browser, a webserver, email client and server routines, client applications, and database applications. In addition, the Offer Source Memory 650 also stores an Operating System 655. These software components may be loaded from a non-transient Computer Readable Storage Medium 695 into Offer Source Memory 650 of the computing device using a drive mechanism (not shown) associated with a non-transient Computer Readable Storage Medium 695, such as a floppy disc, tape, DVD/CD-ROM drive, memory card, or other like storage medium. In some embodiments, software components may also or instead be loaded via a mechanism other than a drive mechanism and Computer Readable Storage Medium 695 (e.g., via Network Interface 630).

The computing device 600 may also comprise hardware supporting input modalities, Optional Input 645, such as, for example, a touchscreen, a keyboard, a mouse, a trackball, a stylus, a microphone, and a camera.

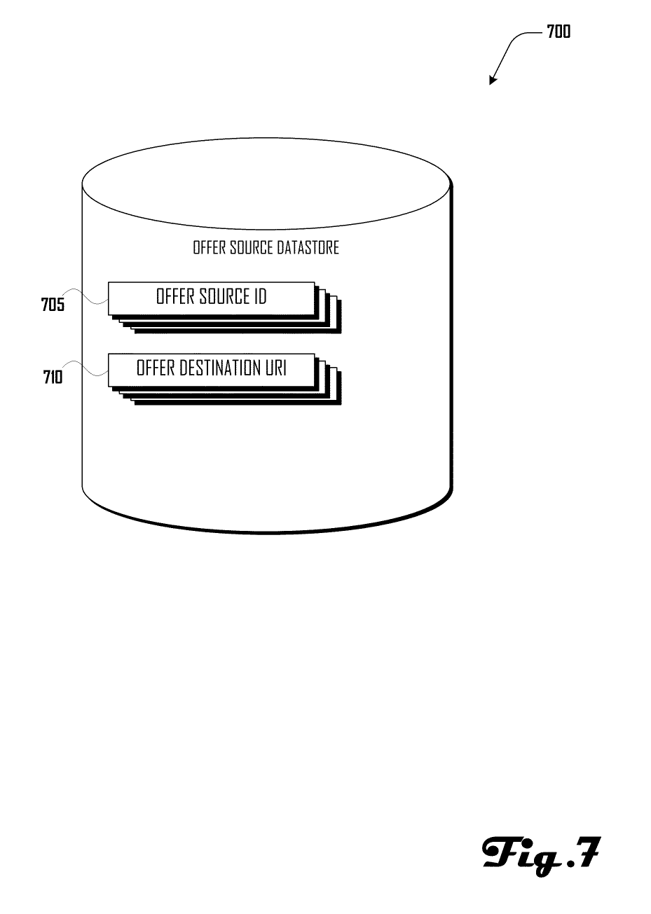

The computing device 600 may also comprise or communicate via Bus 620 with Offer Source Datastore 700, illustrated further in FIG. 7. In various embodiments, Bus 620 may comprise a storage area network (“SAN”), a high speed serial bus, and/or via other suitable communication technology. In some embodiments, computing device may communicate with the Offer Source Datastore via Network Interface 630. The computing device 600 may, in some embodiments, include many more components than those shown in this Figure. However, it is not necessary that all of these generally conventional components be shown in order to disclose an illustrative embodiment.

The Offer Source Computer 600 illustrated in FIG. 6 comprises data groups for routines, such as for a webserver and web browser. Browser and webserver routines may provide an interface for interacting with the other computing devices illustrated in FIG. 1, such as the Injection Server 200, for example, through webserver and web browser routines (which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 7 is a functional block diagram of the Offer Source Datastore illustrated in the computing device of FIG. 6. The components of the Offer Source Computer Datastore 700 are data groups used by routines and are discussed further herein in the discussion of other of the Figures. The data groups used by routines illustrated in FIG. 7 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Certain of the data groups used by routines illustrated in FIG. 7 represent groups of classes of data groups, components of which are further defined herein.

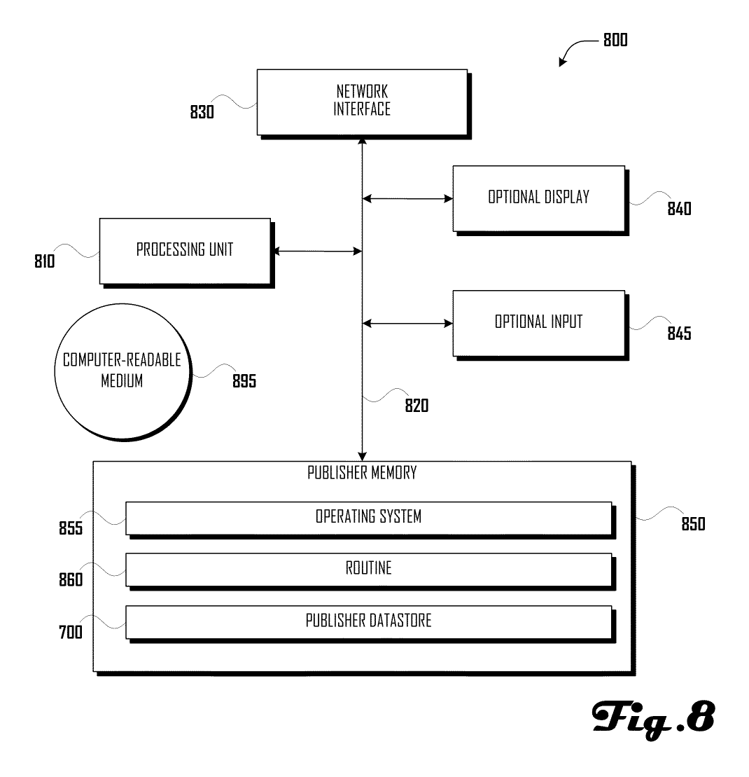

FIG. 8 is a functional block diagram of an exemplary Publisher computing device and some data structures and/or components thereof. The computing device 800 in FIG. 8 comprises at least one Processing Unit 810, Publisher Memory 850, and an Optional Display 840, all interconnected along with the Network Interface 830 via a Bus 820. The Network Interface 830 may be utilized for form connections with the Network 150. The Publisher Memory 850 generally comprises a random access memory (“RAM”), a read only memory (“ROM”), and a permanent mass storage device, such as a disk drive or SDRAM (synchronous dynamic random-access memory). The Publisher Memory 850 stores program code for software routines, such as, for example, a browser, a webserver, email client and server routines, client applications, and database applications. In addition, the Publisher Memory 850 also stores an Operating System 855. These software components may be loaded from a non-transient Computer Readable Storage Medium 895 into Publisher Memory 850 of the computing device using a drive mechanism (not shown) associated with a non-transient Computer Readable Storage Medium 895, such as a floppy disc, tape, DVD/CD-ROM drive, memory card, or other like storage medium. In some embodiments, software components may also or instead be loaded via a mechanism other than a drive mechanism and Computer Readable Storage Medium 895 (e.g., via Network Interface 830).

The computing device 800 may also comprise hardware supporting input modalities, Optional Input 845, such as, for example, a touchscreen, a keyboard, a mouse, a trackball, a stylus, a microphone, and a camera.

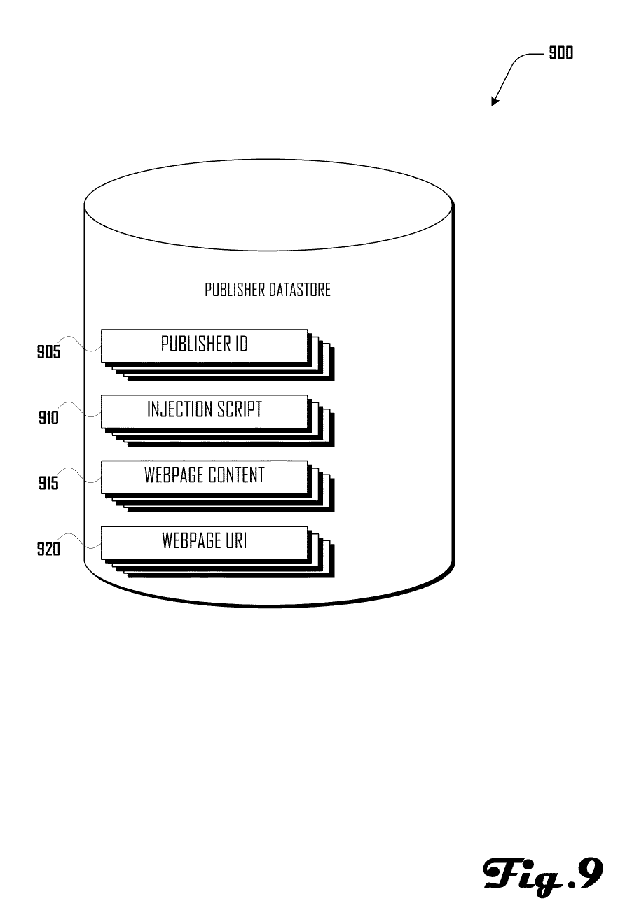

The computing device 800 may also comprise or communicate via Bus 820 with Publisher Datastore 900, illustrated further in FIG. 9. In various embodiments, Bus 820 may comprise a storage area network (“SAN”), a high speed serial bus, and/or via other suitable communication technology. In some embodiments, computing device may communicate with the Publisher Datastore via Network Interface 830. The computing device 800 may, in some embodiments, include many more components than those shown in this Figure. However, it is not necessary that all of these generally conventional components be shown in order to disclose an illustrative embodiment.

The Publisher Computer 800 illustrated in FIG. 8 comprises data groups for routines, such as for a webserver and web browser. Browser and webserver routines may provide an interface for interacting with the other computing devices illustrated in FIG. 1, such as the Injection Server 200 and the Client Devices, for example, through webserver and web browser routines (which may serve and respond to data and information in the form of webpages and html documents or files). The browsers and webservers are meant to illustrate user-interface and user-interface enabling routines generally, and may be replaced by equivalent routines for serving and rendering information to and in a user interface in a computing device (whether in a web browser or in, for example, a mobile device application).

FIG. 9 is a functional block diagram of the Publisher Datastore illustrated in the computing device of FIG. 8. The components of the Publisher Datastore 900 are data groups used by routines and are discussed further herein in the discussion of other of the Figures. The data groups used by routines illustrated in FIG. 9 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Certain of the data groups used by routines illustrated in FIG. 9 represent groups of classes of data groups, components of which are further defined herein.

Login credentials and local instances of customer and user profiles may be stored in or be accessible to all of the computing devices illustrated in FIG. 1, such as in the Injection Server Datastore 300, the Client Device Datastore 500, the Third Party Server 130, the Publisher Datastore 900, and the Offer Source Datastore 700.

The software routines and data groups used by the software routines may be stored and/or executed remotely relative to any of the computers through, for example, application virtualization.

FIG. 10 is a flowchart illustrating an embodiment of an Offer and Script Creation, Webpage Interaction, and Maintenance Process 1000 in which an Injection Server, Offer Source, Publisher, and Client Device interact to create Offers, provide an Injection Script to the Publisher, in which a Publisher serves a Webpage containing the Injection Script, and in which the Client Device renders the Injection Script and interacts with the Injection Server. At box 1005, the Offer Source 600, Publisher 800, and Client Device may (separately) create accounts with the Offer and Script Creation, Webpage Interaction, and Maintenance Process 1000. Creation of an Injection Server account by the Client Device may be optional. Creation of accounts may involve the establishment or providing of credentials to authenticate and authorize a party; credentials may include a login identifier and password, a digital certificate, and similar. Creation of an account may involve providing the login credentials used by the party creating the account at a third party, such as at Third Party Server 130; an example of this is when a party creates an account with the Offer and Script Creation, Webpage Interaction, and Maintenance Process 1000 by providing such party's login credentials with a social media service provider or a search engine service provider, such as with respect to Third Party Server 130. The provided credentials may be authenticated with the Third Party Server 130, to confirm that the credentials correspond to an authenticated user of the social media provider's services, to confirm correspondence between the party and the party with the account with the social media service provider, and to confirm that the Injection Server 200 may access information associated with the account at the social media or search engine service provider. Creation of an account may further involve assigning an identifier to the party or organization who created the account, such as by assigning an Offer Source ID 330, a Client-Widget ID 370, and/or a Publisher ID 380, which identifiers may or may not also be stored at the respective computing devices as Offer Source ID 705, Client-Widget ID 510, and Publisher ID 905. Creation of an account may further involve obtaining contact information for the party, or for a party associated with the party creating the account; examples of records comprising such contact information include the Offer Source Contact Information 364 record and the Publisher Contact Information 387 record. The contact information may comprise, for example, an identifier, a mailing address, an email address, a URI, and similar.

At box 1010, the Offer and Script Creation, Webpage Interaction, and Maintenance Process 1000 may establish for Publishers 800 and/or Offer Sources 600 an Injection Server credit account, which credit account may be used to track consideration owed to or by such party. The credit accounts may be tracked by the Injection Server 200 utilizing, for example, records for Offer Source Credits 335 and Publisher Credits 385.

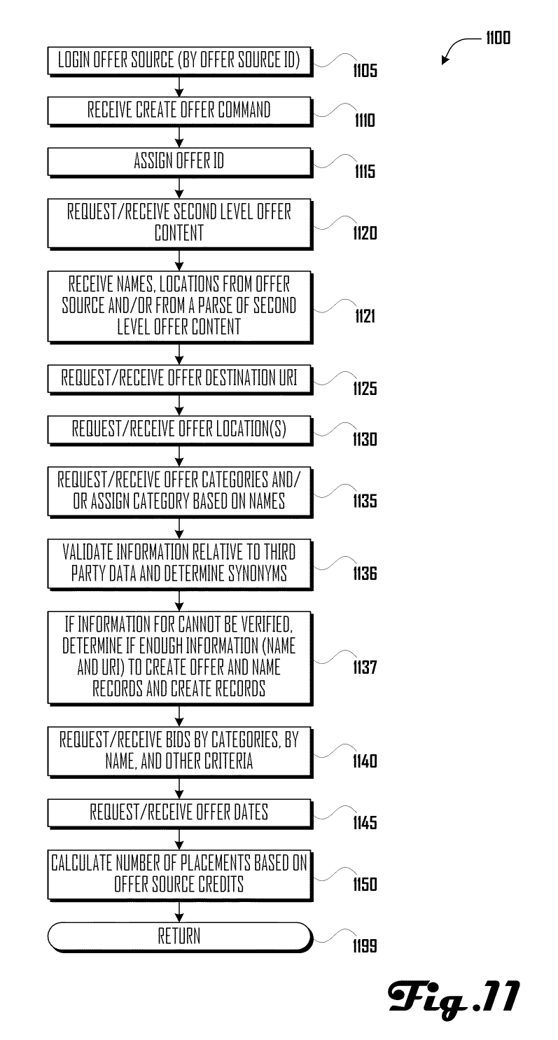

At box 1100, the Offer Creation and Bid Process 1100 interacts with the Offer Source 600 to create Offers and to place and accept bids on the placement of the Offers in Content. This process is discussed further in relation to FIG. 11.

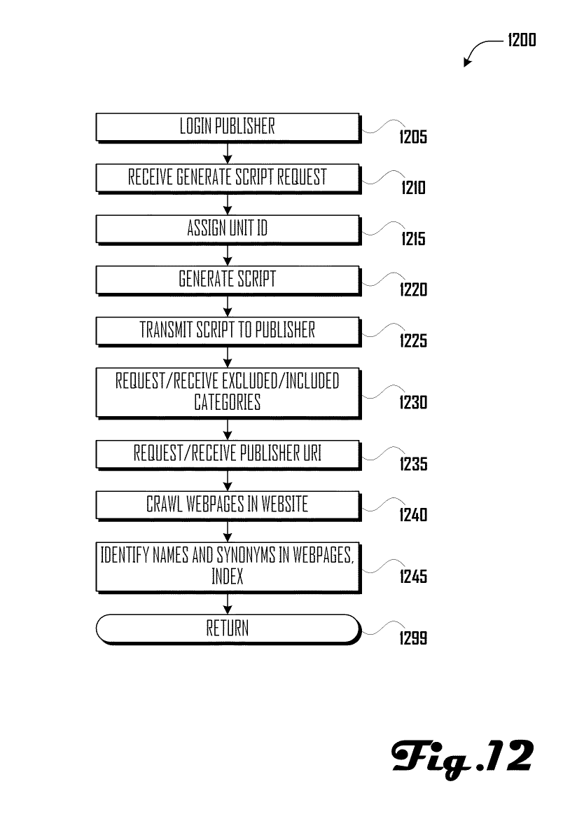

At box 1200, the Injection Script Generation Process 1200 interacts with the Publisher 800 to provide an Injection Script, such as Injection Script 910. The Injection Script 910 may comprise or encode a Unit ID 305. This process is discussed further relation to FIG. 12.

At box 1300, during the Webpage Interaction Process 1300, a Publisher 800 serves Content containing the Injection Script 910 to a Client Device. When rendered by a Client Device, the process, outlined in greater detail in FIG. 13, causes the Webpage Interaction Process 1300 to determine Names in the Content, to match Offers to the Names (and other factors), to serve the matched Offers to the Content, to perform other interactions with the user, credit Publisher 800 accounts or otherwise provide Publishers 800 with consideration for serving the Offer, and debit Offer Sources 600 or otherwise obtain consideration from Offer Sources 600 for placement of the Offers on the Content.

At box 1015 the Offer and Script Creation, Webpage Interaction, and Maintenance Process 1000 obtains Names received during or by the Offer Creation and Bid Process 1100 as well as any URIs, phone number(s), address(es), during or by the Offer Creation and Bid Process 1100 as well as Names identified in Parse Results during the Webpage Interaction Process 1300. At box 1020, data from third parties, such as Third Party Server 130 (or from others), may be obtained containing names, URIs, phone number(s), and address(es) for businesses and other entities. At box 1025, natural language processing may be used to compare the Names, URIs, phone number(s), and address(es) of box 1015 with the obtained data of box 1020. The output of box 1025 may be verification of the information received in box 1015 and/or may be synonyms of the information received in box 1015 (such as alternative spellings, subsidiary names, additional addresses, additional URIs, phone numbers, etc.). The output may be saved in the Injection Server Datastore 300, such as in Name 347 records, which Name 347 records may be associated with Offers, such as by Offer ID 325, and Parse Result 310 records.

At box 1030, the updated set of Names 347 (associated with Offers and Names 347 found in or associated Parse Results 310) are indexed.

At box 1099, the process may end or may return to one of the boxes outlined in FIG. 10.

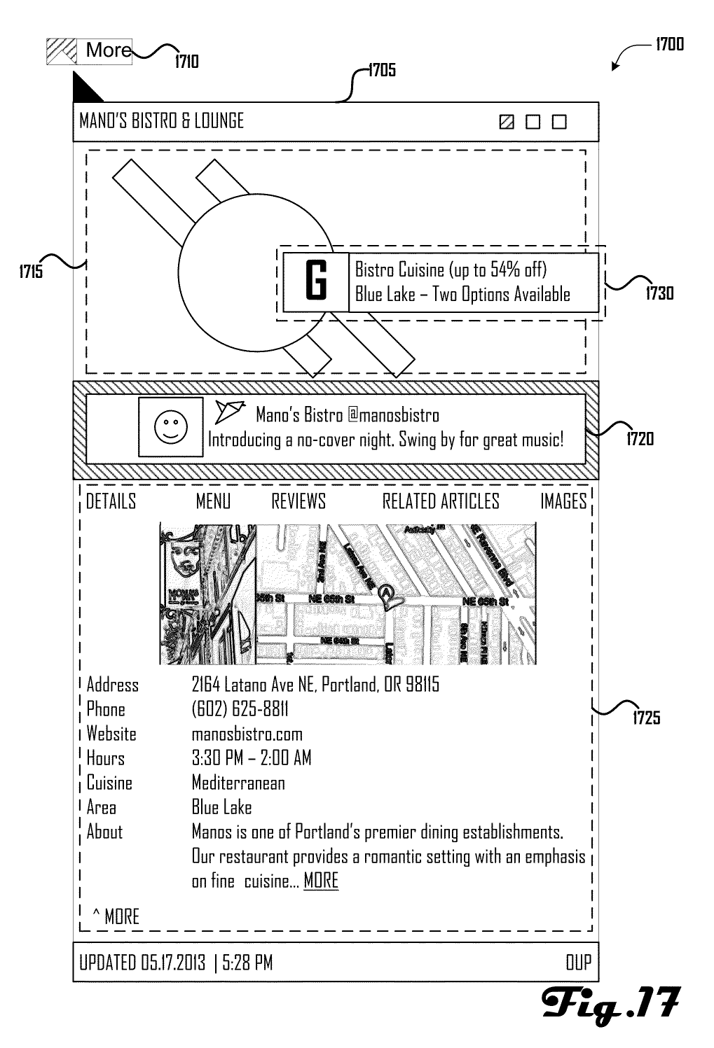

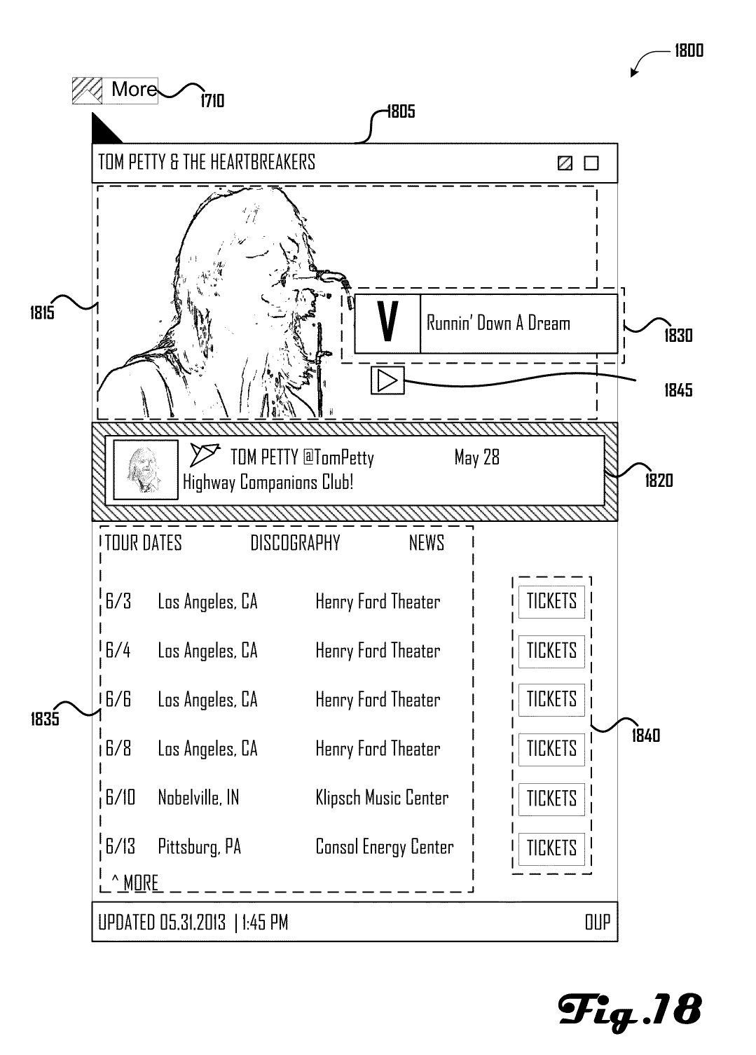

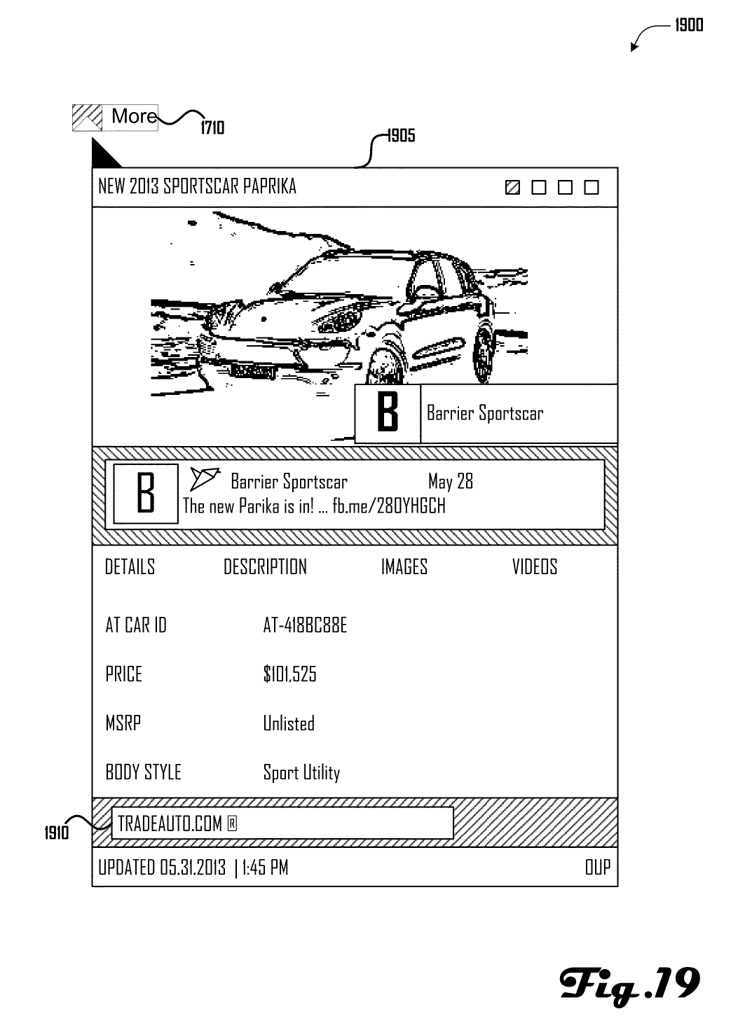

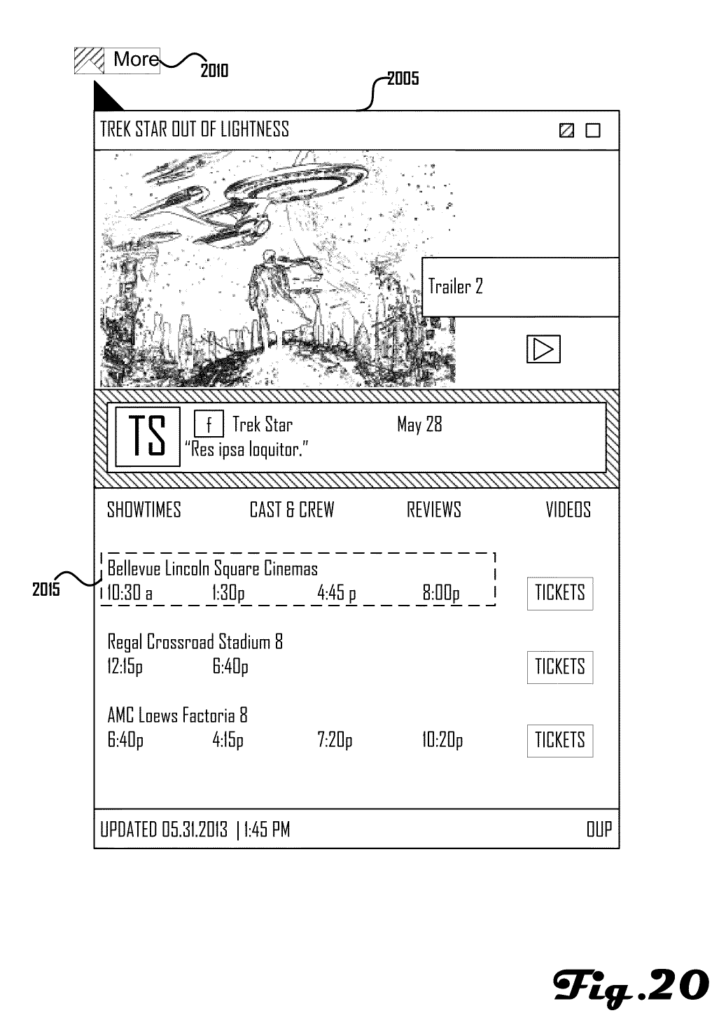

FIG. 11 is a flowchart illustrating an embodiment of an Offer Creation and Bid Process 1100 in which an Offer Source interacts with the Injection Server to create Offers. This process is discussed as occurring in relation to one Offer, though this process may be iterated or performed in bulk, for example, when one Offer Source 600 wishes to establish a large number of Offers and/or when one Offer Source 600 represents a large number of other Offer Sources who may or may not have accounts with the Injection Server 200. At box 1105 the Offer Source 600 logs into the Offer Creation and Bid Process 1100, executed, for example, by the Injection Server 200, such as by providing the Offer Sources's login credentials, which may comprise or be associated with an Offer Source ID 330 previously assigned to the Offer Source 600 when the Offer Source 600 created an account with the Injection Server 200. At box 1110, the Offer Source 600 issues and the Offer Creation and Bid Process 1100 receives a command to create an Offer. At box 1115, the Offer Creation and Bid Process 1100 assigns an Offer ID 325 to the Offer. At box 1120 the Offer Creation and Bid Process 1100 requests and receives from the Offer Source 600 Second Level Offer Content, which the Offer Creation and Bid Process 1100 may store as Second Level Offer Content 360. The Second Level Offer Content 360 may comprise, text, images (including video), audio, and/or links and/or search terms to obtain the same from, for example, the Third Party Server 130. A link to the Second Level Offer Content 360 may comprise, for a link to a social media account of the Offer Source 600 and an indication from the Offer Source 600 that the Offer Source 600 will include a hashtag, or a similar metadata tag, such as #OUP in posts made by the Offer Source 600 to the Offer Source's 600 social media stream. The Webpage Interaction Process 1300 may then, such as at box 1370, obtain or link to the most recent post containing the hashtag made by the Offer Source 600 to the Offer Source's 600 social media stream. Examples of Second Level Offer Content 360 are illustrated in FIG. 14, elements 1420 and 1425, in FIG. 15 at elements 1515, 1520, and 1525, in FIG. 16 at element 1615, in FIG. 17, element 1700 (discussed further below in relation to FIG. 17), in FIG. 18, element 1800 (discussed further below in relation to FIG. 18), in FIG. 19, element 1900 (discussed further below in relation to FIG. 19), and in FIG. 20, element 2000 (discussed further below in relation to FIG. 20).

In an embodiment, some or all of the Second Level Offer Content 360 may be obtained from, for example, the Third Party Server 130 and may comprise, for example, Content uploaded to the Third Party Server 130 by the Offer Source 600 or Content regarding the Offer Source 600 obtained by the Third Part Server 130, such as social media Content or Content from a search engine; in this embodiment, the Offer Source 600 may provide a link to the social media Content or may accept an invitation by the Offer Creation and Bid Process 1100 to link the Offer Creation and Bid Process 1100 to the social media account of the Offer Source 600 or to search results associated with the Offer Source 600. The Second Level Offer Content 360 may be obtained or accessed in advance by the Offer Creation and Bid Process 1100 and/or may be obtained at the time the Client Device interacts with the Offer Banner 1410 (including via an embedded link to the social media Content or a search query link in the Second Level Offer Content 360). The Second Level Offer Content 360 may be transmitted to and displayed by the Client Device after the user of the Client Device interacts with the Offer Banner 1410.

At box 1121, the Second Level Offer Content 360 may be parsed by the Offer Creation and Bid Process 1100 to identify Names and/or the Offer Source 600 may identify Names in or to be associated with the Second Level Offer Content 360. Identified Names may be stored as, for example, Name 347 records associated with Offers, such as via an Offer ID 325 record. Examples of Second Level Offer Content 360 obtained from social media or search engine services companies are illustrated in FIGS. 17 through 20. For example, in FIG. 17, element 1720 may be the then-current most recent “Tweet” from the Offer Source 600, while element 1725 may be information regarding an Offer Source 600 obtained from a search engine, which information comprises a map, address, phone number, and other information.

At box 1125, the Offer Creation and Bid Process 1100 may request and receive from the Offer Source 600 or may otherwise determine one or more destination URIs, which may be stored as Offer Destination URI 340. When the user clicks on the Second Level Offer Content 360, the user may be directed to the Offer Destination URI 340. Different components of the Second Level Offer Content 360 may be associated with different Offer Destination URIs 340. The user may be directed to the Offer Destination URI 340 when the user interacts with the Offer Content and/or the user may be directed to the Offer Destination URI 340 following redirection by the Injection Server 200 and the Webpage Interaction Process 1300 (which may allow the Webpage Interaction Process 1300 to log the event).

At box 1130 the Offer Creation and Bid Process 1100 may request and receive from the Offer Source 600, from a search engine (via, for example, an Offer Destination URI 340), or may otherwise determine locations which may be associated with the Offer, which may be stored as Offer Locations 350. The Offer Locations 350 may comprise one or more addresses of or associated with the Offer Source 600, addresses of events to be offered by the Offer Source 600 (such as concerts and venues), and the like. In the Webpage Interaction Process 1300, the Injection Server 200 may use the Offer Locations 350 to identify Offers associated with a location of a user.

At box 1135 the Offer Creation and Bid Process 1100 may request and receive from the Offer Source 600 categories which may be associated with the Offer and/or the Offer Creation and Bid Process 1100 may assign a Category 320 to the Offer, such as based on a Category 320 associated with a Name, such as in the Map Names to Categories 315, which may be stored as Categories 320. In the Webpage Interaction Process 1300, the Injection Server 200 may use the Categories 320 to identify Offers associated with Names identified in the Content (discussed further below as Parse Results 310), to identify an Ad Unit Template 395 for the Second Level Offer Content 360, and/or to exclude Offers associated with Categories 320 with which a Publisher may not wish to be associated.

At box 1136, the information received in boxes 1121, 1125, 1130, and 1135 may be validated relative to third party data, similar to the process described above with respect to boxes 1020, and 1025 (utilizing natural language processing), with the output being validated information and/or synonyms of the information (which may be stored in, for example, the Names 347, Categories 320, and Offer Locations 350 records).

At box 1137, if the information of boxes 1121, 1125, 1130, and 1135 cannot be validated relative to third party data (such as if there is no or insufficient correspondence), then a determination may be made whether there is a minimum set of information required to create an Offer, such as a Name and a URI. If there is not a minimum set of information, the Offer Source 600 may be notified and additional information requested.

At box 1140, the Offer Creation and Bid Process 1100 may request and receive bids from the Offer Source 600 to place the created Offer according to the Categories 320, by Names (discussed further below as Parse Results 310), or according to other criteria. The bids may obligate the Offer Source 600 to pay consideration for the placement of and/or user interaction with the Offer, which payment may be recorded in the Offer Source Credit 335 record.

At box 1145 (which, like other of the boxes illustrated in this paper, may be performed in another order), the Offer Creation and Bid Process 1100 may request and receive the dates (or date-times) during which the Offer is to remain active. The dates may be recorded in the Offer Dates 362 record.

At box 1150 (which like other of the boxes herein, may be optional), the Offer Creation and Bid Process 1100 may calculate the number of placements of the Offer which the Offer Source's 600 then-current Offer Source Credit 335 record would allow. This amount may be transmitted to and rendered for the Offer Source 600. The process may then return to the process outlined in FIG. 10.

FIG. 12 is a flowchart illustrating an embodiment of an Injection Script Generation Process 1200 in which an Injection Script is provided to a Publisher. At box 1205, a Publisher 800 logs into the Injection Script Generation Process 1200 (which may be executed by, for example, the Injection Server 200), such as by providing the Publisher's login credentials, which may comprise or be associated with a Publisher ID 380 previously assigned to the Publisher 800 when the Publisher 800 created an account with the Injection Server 200.

At box 1210, the Publisher 800 issues and the Injection Script Generation Process 1200 receives a command to generate an Injection Script. At box 1215, the Injection Script Generation Process 1200 assigns a Unit ID 305 to the transaction.

At box 1220, an Injection Script is generated. The Injection Script may be a javascript or similar which is included by the Publisher in Webpage Content 915 and which Injection Script may cause an Offer Banner to be rendered by a Client Device when rendering the Publisher's 800 Content (as discussed further below in relation to FIG. 13). The Injection Script may be generated by a process executed on the Publisher's 800 computing device or on the Injection Server 200, provided that at the conclusion of the process, the Publisher 800 has an Injection Script stored, for example, in the Publisher Memory 850 as Injection Script 910, which Injection Script 910 comprises or encodes at least the Unit ID 305 assigned at box 1215. If the process for generating the Injection Script occurs on the Injection Server 200, at box 1225 the Injection Script may be transmitted to the Publisher 800; the transmitted Injection Script may be copied and pasted into the Content by the Publisher and may be displayed in, for example, a browser. The transmitted Injection Script may be transmitted to the Publisher 800 as part of an API command-response, or similar, and may be programmatically incorporated into the Content.

At box 1230, the Injection Script Generation Process 1200 may request and the Publisher 800 may provide a Category 320, which Category 320 may be used to include or exclude Offers associated with the Category 320. For example, an Offer may be for lingerie, which may be associated with a Category 320 such as, “adult only.” A Publisher 800 of children's books may wish to exclude Offers in the “adult only” Category 320. Alternatively, the Publisher 800 may be able to provide a Category 320 which will be used to filter for Offers associated with the provided Category 320.

At box 1235, the Injection Script Generation Process 1200 may request and receive from the Publisher 800 a URI, such as a Webpage URI 920, which may be used, for example, to obtain the Webpage Content 915. At box 1240, the Injection Script Generation Process 1200 may utilize the URI to get a webpage. The Injection Script Generation Process 1200 may identify links in the webpage within the same domain as the URI and may crawl such pages (a so-called “wild” crawl of the website) and/or the Injection Script Generation Process 1200 may identify a site map and may crawl webpages identified in the site map. In crawling the webpages, the Injection Script Generation Process 1200 may parse the webpages to produce Parse Results 310, which Parse Results 310 may exclude dynamic content in the webpages, such as advertisements.

At box 1245, the Injection Script Generation Process 1200 may identify Names, such as Names 347, in the Parse Results 310 or other result of box 1240. Names identified in a Parse Result 310 may be recorded by an association between the two records. Similar to boxes 1020 and 1025, box 1245 may also obtain third party data for Names and may perform natural language processing to compare the Names identified in box 1245 to the third party data to identify synonyms thereof, with the synonyms also being stored in the Name 347 records. The Names and synonyms may be indexed.

The process may then return to the process outlined in FIG. 10.

FIG. 13 is a flowchart illustrating an embodiment of a Webpage Interaction Process 1300 in which a Publisher serves Content containing the Injection Script and the Client Device renders the Injection Script. The Webpage Interaction Process 1300 may be performed by the Injection Server 200. At box 1305, the Publisher serves Content comprising an Injection Script; the Content may be accessed at the Webpage URI 920. At box 1310, a Client Device renders the Content. Box 1315 illustrates an optional decision box in which a determination may be made by the Webpage Interaction Process 1300 regarding whether the Client Device comprises an optional Widget Client-Side Process 460. The Widget Client-Side Process 460 may be a routine, such as an “App” or browser plugin or similar, which interacts with the Injection Server 200 and the Webpage Interaction Process 1300. Depending on the implementation, no decision may be made at box 1315, but rather if the Widget Client-Side Process 460 is present or not present on the Client Device, then the Webpage Interaction Process 1300 may receive a notice from the Client Device (such as via a conditional logic http request for a non-visible Content element by the Client Device, which conditional logic request may only be initiated absent the Widget Client-Side Process 460, which conditional logic request may comprise or encode the Unit ID 305) which may be logged at box 1398 by the Injection Server 200. At box 1320 the Injection Script causes the Client Device and/or the Widget Client-Side Process 460 to send to the Injection Server 200, for example, the Unit ID 305, a Client-Widget ID 510 (which may have been assigned to the Widget Client-Side Process 460 when the Client Device creates an account with the Injection Server 200), and the Webpage URI 920. At box 1320, the Injection Script may cause the Client Device and/or the Widget Client-Side Process 460 to further request (or the previous communications may be treated as a request for) an Offer Banner, such as Offer Banner 1410. At box 1322, the location of the Client Device may be determined from, for example, the IP address used by the Client Device cookies in the Client Device, and the like; the location of the Client Device may also be obtained from, for example the Widget Location 375 record.

At box 1325, the Injection Server 200 may make a decision regarding whether this is the first encounter by the Injection Server 200 with the Content. This decision may be based, for example, on the Webpage URI 920 and/or the Unit ID 305. If it is determined that this is the first encounter by the Webpage Interaction Process 1300 with the Content, then at box 1330 the Webpage Interaction Process 1300 may access the Content, such as via the Webpage URI 920, and may parse the Content for Names and similar which may be associated with Offers. Parsing the Content may distinguish between portions of the Content which are not (or not likely to have been) provided by the Publisher, such as advertisements, and portions of the Content which are provided by the Publisher. Portions which are not provided by the Publisher may not be parsed. At box 1335, the Names and similar which may be associated with Offers may be stored, for example, as Parse Results 310 records. The Parse Results 310 may be stored in association with Categories 320 based on existing categorization schemas which match, for example, a Name to a Category 320, as well as in association with the Unit ID 305, and/or the Webpage URL 920.

At box 1340, which may be optional if the result is already in the Injection Server Memory 250, the stored Parse Results 310 may be obtained. At box 1345, a determination may be made regarding whether there are any Parse Results 310. If there are not, then at box 1397, the Webpage Interaction Process 1300 may log the event and may then go to box 1399. If there are, then at box 1350 the Webpage Interaction Process 1300 may look up Offers associated with the Parse Results 310. The associated Offers may be associated by Categories excluded or included by the Publisher 800 during the Injection Script Generation Process 1200, by Names which the Offer Source 600 bid on (described in relation to FIG. 11) and Names which are in the Parse Results 310, by location (such as an Offer Location 350 and/or a location associated with a Client Device or Widget Client-Side Process 460, such as Widget Locations 375), and/or by a direct or indirect association between a term, such as a Name, in the Offer and a term, such as a Name, in the Parse Results 310. The associated Offers may optionally be ranked, for example, by the value of the Offer to the user, by the value of the Offer to the Injection Server 200, by proximity of location (such as an Offer Location 350 and/or a location associated with a Client Device or Widget Client-Side Process 460, such as Widget Locations 375), or according to other factors.

At box 1355, the Offer Banner may be transmitted to the Client Device; the transmitted Offer Banner may comprise the number of Offers, as illustrated in Offer Banner 1410. At box 1360, the Client Device renders the Offer Banner, notifies the Webpage Interaction Process 1300 that the Offer Banner was rendered, the Webpage Interaction Process 1300 logs the event, may debit the Offer Source 600 for the “First Level Reveal” (rendering the Offer Banner 1410) and may credit the Publisher 800, such as by changing the value of the Offer Source Credits 335 associated with the Offer Source 600 and the Publisher Credits 385 associated with the Publisher 800.

At box 1365, the Client receives a “First Level Interaction” with the Offer Banner 1410. This “First Level Interaction” may comprise, for example, the user of the Client Device floating a mouse or other pointer on or in the vicinity of the Offer Banner, clicking on the Offer Banner, directing gaze to the Offer Banner, or directing attention to the Offer Banner, which attention is programmed by the Operating System 455, by a browser routine executing on the Client Device, and/or by the Widget Client-Side Process 460 as an interaction with the Offer Banner, which interaction prompts the providing of additional information to the user. The First Level Interaction may also prompt the Client Device and/or the Widget Client-Side Process 460 to request the Second Level Offer Content 360 associated with the Offer(s) associated with the Content (as discussed above), unless the Second Level Offer Content 360 was previously sent and is already available in the Client Device Memory 450.

At box 1370, the Injection Server 200 obtains the Second Level Offer Content 360 associated with the Offer(s) associated with the Content, which may comprise the most recent post made by the Offer Source 600 containing the hashtag included by the Offer Source 600 in posts to the Offer Source's 600 social media stream, or obtains a link to the Second Level Offer Content 360 available at, for example, the Third Party Server 130, which link may comprise a search query comprising the hashtag or another identifier of the Offer Source 600. The obtained Second Level Offer Content 360 and/or link thereto is sent at box 1370 to the Client Device. When sending the Second Level Offer Content 360 as a link, the transmitted link may be appended as a second link to a first link, which first link points to the Injection Server 200, while the second link is used to redirect a Client Device URL request to the second link. The Second Level Offer Content 360 may be formatted according to an Ad Unit Template 395 associated with a Category 320.

At box 1375, the Client Device renders the Second Level Offer Content 360 in the Ad Unit Template 395, illustrated generally, as an example, in FIG. 14, elements 1415, 1420, and 1425, in FIG. 15, elements 1515, 1520, and 1525, in FIG. 16, element 1615, in FIG. 17, element 1700, FIG. 18, element 1800, FIG. 19, element 1900, and FIG. 20, element 2000. The Client Device notifies the Webpage Interaction Process 1300 that this event occurred, the Webpage Interaction Process 1300 logs the event, may debit the Offer Source 600 for the “Second Level Reveal” (rendering the Second Level Offer Content 360), and may credit the Publisher 800, such as by changing the value of the Offer Source Credits 335 associated with the Offer Source 600 and the Publisher Credits 385 associated with the Publisher 800.

At box 1380, the Client Device receives a “Second Level Interaction” with the Second Level Offer Content 360. The “Second Level Interaction” may comprise, for example, the user of the Client Device floating a mouse or other pointer on or in the vicinity of the Second Level Offer Content 360, clicking on the Second Level Offer Content 360, directing gaze to the Second Level Offer Content 360, or directing attention to the Second Level Offer Content 360, as described above in relation to box 1365.

At box 1385, the Client Device directs the Second Level Interaction to the Offer Destination URL 340, either directly or via the Webpage Interaction Process 1300. At box 1390, the Webpage Interaction Process 1300 logs the event, may debit the Offer Source 600 for the event, may credit the Publisher 800 (much as described above), and may redirect the Second Level Interaction to the Offer Destination URL 340. The process may then return to the process outlined in FIG. 10.

The amounts which may be debited from the Offer Source 600 (discussed above) may be amounts related to or derived from the amount bid by the Offer Source 600 for placement of the Offer. The amounts which may be credited to the Publisher 800 (discussed above) may be amounts related to or derived from the amount bid by the Offer Source 600 for placement of the Offer or may be a different amount established with the Publisher.

FIG. 17 illustrates an Offer with an expanded format and additional information. In this embodiment, an example of an Offer Banner 1710 is illustrated, which Offer Banner 1710 would be part of a webpage comprising Content and an Injection Script, served by a Publisher and accessed at, for example, a Webpage URL 920. The Offer 1700 is formatted according to an Ad Unit Template 395, which Ad Unit Template 395 comprises areas for graphics, such as element 1715, an area in element 1730 for a coupon promotion, element 1720 comprising Content from one of Offer Source's 600 social media providers, and element 1725 comprising Content from a search engine. The Offer 1700 may have been categorized as, for example a restaurant.

FIG. 18 illustrates an Offer with an expanded format and additional information. In this embodiment, the Offer Banner 1710 is illustrated and the Offer 1800 is formatted according to an Ad Unit Template 395, which Ad Unit Template 395 comprises areas for graphics, such as element 1815 (which graphics may be drawn from, for example, a social media provider associated with the Offer Source 600), an area in element 1830 for a song by or promoted by the Offer Source 600, element 1845 to play the song, element 1820 comprising Content from one of Offer Source's 600 social media providers, element 1835 comprising concert dates, and element 1840 comprising buttons which may be selected to purchase tickets to see the shows. The Offer 1700 may have been categorized as, for example a musician.

FIG. 19 illustrates an Offer with an expanded format and additional information. In this embodiment, the Offer 1900 comprises Content from one of Offer Source's 600 social media providers and Content from a search engine. The Offer 1900 may further comprise information at element 1910 regarding the source of the search engine. The Offer 1900 may have been categorized as, for example, an automobile sales offer.

FIG. 20 illustrates an Offer with an expanded format and additional information. In this embodiment, the Offer 2000 comprises Content from one of Offer Source's 600 social media providers and Content, at element 2015, from a search engine regarding venue locations associated with the Offer Source 600. The location of the user may be obtained (such as at box 1322) and the search engine venue locations may be queried with the user's location in addition to information regarding the Offer Source 600. The Offer 2000 may have been categorized as, for example, a movie.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of providing content associated with a webpage performed in a computer comprising a memory, the method comprising:
receiving at the computer from a client device a URI and an identifier associated with a publisher in a database of the computer, which identifier was placed in the webpage by the publisher;
at the computer, if the identifier associated with the publisher and the URI have not previously been received from any client device, utilizing the URI to obtain a webpage and parsing the webpage to identify at least one target name by comparing text in at least a first part of the webpage to a list of target names, which target names are obtained from an offer source, and storing the result as a webpage parse result, else utilizing the URI to obtain a previously stored webpage parse result;
at the computer, identifying at least one target name in the webpage parse result;
at the computer, determining the number of target names in the webpage parse result;
at the computer, selecting at least one offer associated with the at least one target name identified in the stored webpage parse result;
transmitting an offer banner from the computer to the client device, which offer banner comprises the determined number of target names in the webpage parse result, which offer banner is included in the webpage as rendered by the client device, and which offer banner does not include an offer;
receiving at the computer a first request from the client device for an offer, which request is associated with the offer banner;
at the computer and in response to the first request, transmitting at least one of the at least one selected offer to the client device, wherein the transmitted selected offer comprises an identifier of a URI obtained from an offer source;
at the computer, receiving a second request from the client device, which second request comprises the identifier of a URI obtained by the computer from the offer source;
by the computer, responding to the second request from the client device with the URI obtained from the offer source; and
by the computer, processing a payment indication to receive a payment from the offer source for transmitting the URI obtained from the offer source to the client device.

2. The method according to claim 1, further comprising determining a first location associated with the parse result and wherein the offer is associated with a second location associated with the offer and wherein the offer is selected, at least in part, based on proximity of the first and second locations.

3. (canceled)

4. The method according to claim 1, further comprising determining synonyms for the target names obtained from the offer source and adding the determined synonyms to the list of target names.

5. The method according to claim 1, wherein selecting at least one offer further comprises obtaining a category associated with the URI and excluding or including the at least one offer based on whether the at least one offer is associated with the obtained category.

6. The method according to claim 1, further comprising recording that at least one of the offer banner and the offer was rendered by the client device.

7. (canceled)

8. The method according to claim 1, further comprising receiving notification from the client device that the offer banner was rendered by the client device.

9. The method according to claim 1, wherein the offer further comprises a URI associated with the computer and the identifier of a URI obtained from the offer source.

10. The method according to claim 9, wherein when the client device selects the offer, the client device follows the URI associated with the computer and is redirected to the URI obtained from the offer source.

11. The method according to claim 1, wherein the offer comprises content from at least one of a social media service provider and a search services provider.

12. The method according to claim 11, wherein the content from the at least one of the social media service provider and the search services provider comprises at least one of a map of the offer source's location, and contact information for the offer source.

13. The method according to claim 11, further comprising, obtaining the content from the at least one of the social media service provider and the search services provider and transmitting the offer to the client device, which offer comprises the obtained content.

14. The method according to claim 11, further comprising obtaining a hashtag from the offer source, which hashtag identifies posts made by the offer source to the social media service provider, and wherein the content from the social media service provider is obtained by searching for the hashtag in posts made by the offer source to the social media service provider.

15. The method according to claim 1, wherein the offer comprises a discount offered in relation to the offer source.

16. (canceled)

17. The method according to claim 1, wherein the payment is based on a bid submitted by the offer source.

18. The method according to claim 17, wherein selecting the offer further comprises selecting an offer with the highest bid in relation to target names in the parse result.

19. The method according to claim 1, further comprising processing a payment indication to make a payment to a provider of the webpage for including the offer in the webpage.

20. The method according to claim 1, further comprising maintaining payment accounts for the offer source and for a provider of the webpage and wherein processing the payment indication to receive payment from the offer source comprises debiting the offer source account.

21. A computing apparatus for providing content associated with a webpage, the apparatus comprising a processor and a memory storing instructions that, when executed by the processor, configure the apparatus to:
receive at the computer from a client device a URI and an identifier associated with a publisher in a database of the computer, which identifier was placed in the webpage by the publisher;
at the computer, if the identifier associated with the publisher and the URI have not previously been received from any client device, utilize the URI to obtain a webpage and parse the webpage to identify at least one target name by comparing text in at least a first part of the webpage to a list of target names, which target names are obtained from an offer source, and store the result as a webpage parse result, else utilize the URI to obtain a previously stored webpage parse result;
at the computer, identify at least one target name in the webpage parse result;
at the computer, determine the number of target names in the webpage parse result;
at the computer, select at least one offer associated with the at least one target name identified in the stored webpage parse result;
by the computer, transmit an offer banner to the client device, which offer banner comprises the determined number of target names in the webpage parse result, which offer banner is included in the webpage as rendered by the client device, and which offer banner does not include an offer;
at the computer, receive a first request from the client device for an offer, which request is associated with the offer banner;
at the computer and in response to the first request, transmit at least one of the at least one selected offer to the client device, wherein the transmitted selected offer comprises an identifier of a URI obtained from an offer source;
at the computer, receive a second request from the client device, which second request comprises the identifier of a URI obtained by the computer from the offer source;
by the computer, respond to the second request from the client device with the URI obtained from the offer source; and
by the computer, process a payment indication to receive a payment from the offer source for transmitting the URI obtained from the offer source to the client device.

22. A non-transient computer-readable storage medium having stored thereon instructions that, when executed by a processor in a computer, configure the processor to:
receive at the computer from a client device a URI and an identifier associated with a publisher in a database of the computer, which identifier was placed in the webpage by the publisher;
at the computer, if the URI has not previously been received from any client device, utilize the URI to obtain a webpage and parse the webpage to identify at least one target name and store the result as a webpage parse result by comparing text in at least a first part of the webpage to a list of target names, which target names are obtained from an offer source, else utilize the URI to obtain a previously stored webpage parse result;
at the computer, identify at least one target name in the webpage parse result;
at the computer, determine the number of target names in the webpage parse result;
at the computer, select at least one offer associated with the at least one target name identified in the stored webpage parse result;
transmit an offer banner from the computer to the client device, which offer banner comprises the determined number of target names in the webpage parse result, which offer banner is included in the webpage as rendered by the client device, and which offer banner does not include an offer;
receive at the computer a first request from the client device for an offer;
at the computer and in response to the first request, transmit at least one of the at least one selected offer to the client device, wherein the transmitted selected offer comprises an identifier of a URI obtained from an offer source;
at the computer, receive a second request from the client device, which second request comprises the identifier of a URI obtained by the computer from the offer source;
by the computer, respond to the second request from the client device with the URI obtained from the offer source; and
by the computer, process a payment indication to receive a payment from the offer source for transmitting the URI obtained from the offer source to the client device.

23. A method of obtaining an offer to pay consideration in exchange for serving content to a webpage, which method is performed in a computer comprising a memory, the method comprising:
receiving a request from an offer source to create an offer, which offer is to be transmitted to a client device when the client device renders a webpage;
assigning an identifier to the request;
identifying content to transmit to the client device as part of the offer;
receiving at least one of a name, a location, a category, and a date range to associate with the offer; and
receiving a bid from the offer source to transmit the offer to a client device when the client device renders a webpage.

24. The method according to claim 23, wherein identifying content to transmit to the client device comprises receiving an identifier of the offer source at least one of a social media service provider and a search engine service provider and utilizing the identifier to obtain the content from the at least one social media service provider and search engine service provider.

25. The method according to claim 23, further comprising determining synonyms for the name associated with the offer.
